(19) United States
(12) Patent Application Publication
(10) Pub. No.: US 2025/0334842 A1
(43) Pub. Date: Oct. 30, 2025

(54) ACTIVE MATRIX SUBSTRATE, METHOD OF MANUFACTURING ACTIVE MATRIX SUBSTRATE, AND LIQUID CRYSTAL DISPLAY DEVICE

(71) Applicants: Sharp Display Technology Corporation, Kameyama City (JP); SHARP KABUSHIKI KAISHA, Osaka (JP)

(72) Inventors: Makoto NAKAZAWA, Kameyama City (JP); Kazuatsu ITO, Kameyama City (JP); Hiroaki FURUKAWA, Osaka (JP); Akinori KUBOTA, Kameyama City (JP)

(21) Appl. No.: 19/169,926

(22) Filed: Apr. 3, 2025

(30) Foreign Application Priority Data
Apr. 25, 2024 (JP) 2024-071746

(51) Int. Cl. G02F 1/1368; G02F 1/1362

(52) U.S. Cl. CPC G02F 1/1368; G02F 1/136286

(57) ABSTRACT

An active matrix substrate includes a substrate, a TFT, a plurality of gate wiring lines, and a plurality of source wiring lines. A light transmitting portion is provided, the TFT, the gate wiring line, and the source wiring line not being disposed at the light transmitting portion. An interlayer film includes a silicon nitride layer formed of silicon nitride and a silicon oxide layer formed of silicon oxide. The interlayer film includes a first portion at the light transmitting portion, the first portion not including the silicon nitride layer.

### CROSS-REFERENCE TO RELATED APPLICATIONS

This application claims the benefit of priority to Japanese Patent Application Number 2024-071746 filed on Apr. 25, 2024. The entire contents of the above-identified application are hereby incorporated by reference.

### BACKGROUND

### Technical Field

The disclosure relates to an active matrix substrate, a method of manufacturing an active matrix substrate, and a liquid crystal display device.

A liquid crystal display device including an active matrix substrate is being widely used in various applications. The active matrix substrate includes a thin film transistor (hereinafter referred to as a “TFT”), which serves as a switching element for each of pixel regions. The thin film transistor is supported by a transparent substrate made of glass or the like. A gate wiring line for supplying a gate signal to the thin film transistor, a source wiring line for supplying a source signal to the thin film transistor, a pixel electrode, and the like are formed on the substrate. A gate electrode, a source electrode, and a drain electrode of the thin film transistor are electrically connected to the gate wiring line, the source wiring line, and the pixel electrode, respectively.

A gate insulating film is provided between a semiconductor layer and the gate electrode of the thin film transistor. An interlayer film is provided between a metal layer of the gate electrode and a metal layer of the source electrode and the drain electrode of the thin film transistor. A flattening film for leveling the surface is formed on the interlayer film. The pixel electrode is electrically connected to the drain electrode of the thin film transistor, inside a contact hole formed in the flattening film.

In a display such as a liquid crystal display device, mesopic contrast is regarded as important in order to improve viewability, but in recent years, photopic contrast is also attracting attention. Methods to improve the photopic contrast include a method that increases the brightness of a backlight or the like, but this leads to an increase in power consumption. Thus, reducing internal reflection and improving transmittance are urgent issues.

JP 2021-071725 A discloses a configuration in which, in order to improve transmittance, in a layered film including a thin film transistor, a light transmitting opening is provided in a region other than a circuit portion extending into a light transmitting region. In JP 2021-071725 A, the layered film is completely removed until a surface of a substrate is exposed.

### SUMMARY

When removing the layered film, an organic film can be easily removed by using a photosensitive material. However, since an inorganic film can only be removed by etching, when the layered film is completely removed, there is concern about the influence of distribution, residues, and the like, and there is concern about the influence on the transmittance. There is also a problem in that a long processing time is required to remove the inorganic film, and a device load is extremely large.

In light of the foregoing, an object of an aspect of the disclosure is to realize an active matrix substrate, a method of manufacturing the active matrix substrate, and a liquid crystal display device capable of improving a photopic contrast while suppressing a device load.

In order to resolve the above-described issues, an active matrix substrate according to an aspect of the disclosure including a plurality of pixel regions arrayed in a matrix shape includes a substrate, and a TFT supported on the substrate and provided corresponding to each of the plurality of pixel regions, the TFT including a semiconductor layer, a gate electrode, a gate insulating film, a source electrode and a drain electrode, and an interlayer film. The active matrix substrate includes a plurality of gate wiring lines formed from the same conductive film as the gate electrode, and extending in a row direction, and a plurality of source wiring lines formed from the same conductive film as the source electrode and the drain electrode, and extending in a column direction. A light transmitting portion is provided, the TFT, the gate wiring line, and the source wiring line not being disposed at the light transmitting portion. The interlayer film includes a silicon nitride layer formed of silicon nitride and a silicon oxide layer formed of silicon oxide, and the interlayer film includes a first portion at the light transmitting portion, the first portion not including the silicon nitride layer.

In order to resolve the above-described issues, a liquid crystal display device according to an aspect of the disclosure includes the active matrix substrate according to the aspect of the disclosure, a counter substrate disposed facing the active matrix substrate, and a liquid crystal layer provided between the active matrix substrate and the counter substrate.

In order to resolve the above-described issues, a method of manufacturing an active matrix substrate according to an aspect of the disclosure is a method of manufacturing an active matrix substrate that includes a substrate and a TFT, the TFT being supported on the substrate and being provided corresponding to each of a plurality of pixel regions arrayed in a matrix shape, the TFT including a semiconductor layer, a gate electrode, a gate insulating film, a source electrode and a drain electrode, and an interlayer film, and the active matrix substrate including a light transmitting portion at which the TFT, a gate wiring line, and a source wiring line are not disposed. The method includes interlayer film forming of forming an interlayer film covering the gate electrode and the gate wiring line, the interlayer film including a silicon nitride layer formed of silicon nitride and a silicon oxide layer formed of silicon oxide. The method includes hydrogenating of repairing defects in the semiconductor layer, using hydrogen supplied from the silicon nitride layer, and inorganic film removing of, subsequent to the hydrogenating, removing the silicon nitride layer in at least a part of the interlayer film located at the light transmitting portion, to form a removed region, the silicon nitride layer not being present in a film thickness direction in the removed region.

According to an aspect of the disclosure, it is possible to realize an active matrix substrate, a method of manufacturing the active matrix substrate, and a liquid crystal display device capable of improving a photopic contrast while suppressing a device load.

### BRIEF DESCRIPTION OF DRAWINGS

The disclosure will be described with reference to the accompanying drawings, wherein like numbers reference like elements.

FIG. 1 is a plan view schematically illustrating an active matrix substrate according to a first embodiment.

FIG. 2 is a cross-sectional view schematically illustrating the active matrix substrate illustrated in FIG. 1.

FIG. 3 is a process view illustrating a manufacturing process, together with cross-sectional views, of the active matrix substrate illustrated in FIG. 1.

FIG. 4 is a process view illustrating the manufacturing process, together with cross-sectional views, of the active matrix substrate illustrated in FIG. 1.

FIG. 5 is a process view illustrating the manufacturing process, together with cross-sectional views, of the active matrix substrate illustrated in FIG. 1.

FIG. 6 is a process view illustrating the manufacturing process, together with cross-sectional views, of the active matrix substrate illustrated in FIG. 1.

FIG. 7 is a cross-sectional view schematically illustrating an active matrix substrate according to a second embodiment.

FIG. 8 is a process view illustrating a manufacturing process, together with cross-sectional views, of the active matrix substrate illustrated in FIG. 7.

FIG. 9 is a plan view schematically illustrating an active matrix substrate according to a third embodiment.

FIG. 10 is a cross-sectional view schematically illustrating the active matrix substrate illustrated in FIG. 9.

FIG. 11 is a cross-sectional view taken along a line I-I′ in FIG. 9.

FIG. 12 is a cross-sectional view taken along a II-II line in FIG. 9.

FIG. 13 is a process view illustrating a manufacturing process, together with cross-sectional views, of the active matrix substrate illustrated in FIG. 9.

FIG. 14 is a plan view schematically illustrating an active matrix substrate according to a fourth embodiment.

FIG. 15 is a cross-sectional view schematically illustrating the active matrix substrate illustrated in FIG. 14.

FIG. 16 is a cross-sectional view taken along a III-III line in FIG. 14.

FIG. 17 is a cross-sectional view taken along a line IV-IV in FIG. 14.

FIG. 18 is a process view illustrating a manufacturing process, together with cross-sectional views, of the active matrix substrate illustrated in FIG. 14.

FIG. 19 is a cross-sectional view illustrating processing inside a contact hole opened in a flattening film, in the active matrix substrate illustrated in FIG. 14.

FIG. 20 is a view illustrating a positional relationship between a drain electrode and a contact hole opened in the flattening film, in the active matrix substrate illustrated in FIG. 14.

FIG. 21 is a cross-sectional view taken along a line V-V in FIG. 20.

FIG. 22 is a cross-sectional view taken along a VI-VI line in FIG. 20.

FIG. 23 is a cross-sectional view schematically illustrating an active matrix substrate according to a fifth embodiment.

FIG. 24 is a cross-sectional view schematically illustrating a liquid crystal display device according to the fifth embodiment.

### DESCRIPTION OF EMBODIMENTS

The present inventors have carried out intensive investigations with the intention of improving photopic contrast in a liquid crystal display device. As a result, the present inventors have found that an SiNx (silicon nitride) film present at a light transmitting portion, particularly an SiNx film of an interlayer film of a thin film transistor, is a factor that increases internal reflection. This has led to the disclosure claimed herein.

The light transmitting portion is a portion through which light from a backlight is transmitted when the liquid crystal display device is viewed in a plan view. In other words, the light transmitting portion is a portion through which the light of the backlight passes, excepting a portion at which the light is blocked by a gate wiring line, a source wiring line, and a thin film transistor provided in an active matrix substrate, and a portion at which the light is blocked by a light blocking layer or the like provided at a counter substrate.

The photopic contrast in the liquid crystal display device can be improved by removing the SiNx film of the interlayer film present at the light transmitting portion. Hereinafter, a description will be given of a structure of the active matrix substrate and a method of manufacturing the active matrix substrate capable of improving the photopic contrast by removing the SiNx film of the interlayer film, while suppressing a device load.

Below, embodiments of the disclosure will be described with reference to the accompanying drawings.

### First Embodiment

### Configuration of Active Matrix Substrate

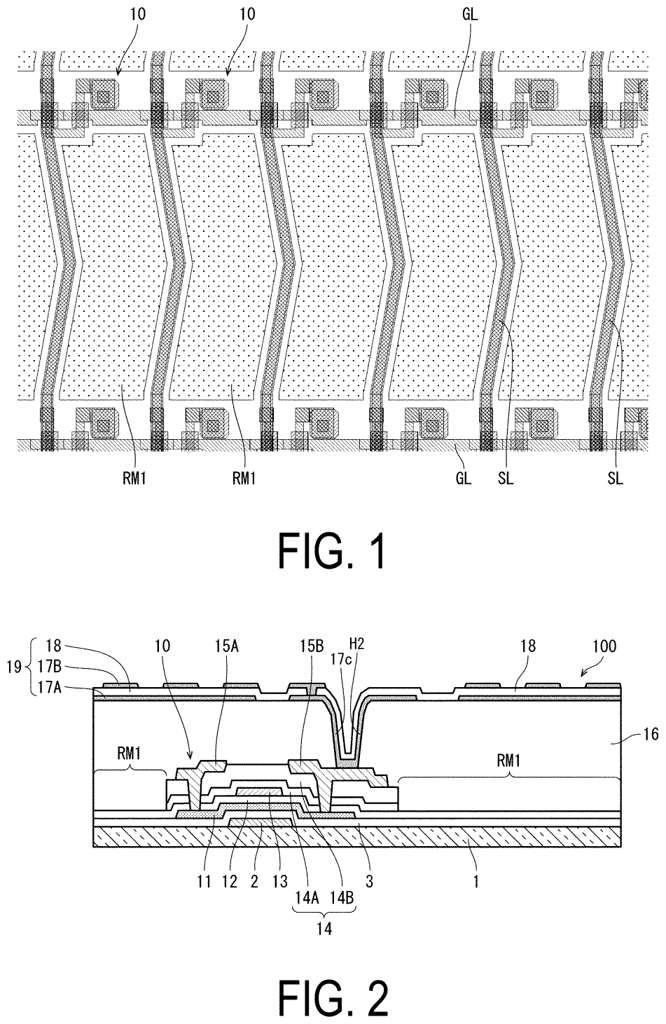

First, a configuration of an active matrix substrate 100 according to a first embodiment will be described with reference to FIGS. 1 and 2. FIG. 1 is a plan view schematically illustrating the active matrix substrate 100 according to the first embodiment. In FIG. 1, a dotted regions is an interlayer film removed region RM1, obtained by removing an interlayer film 14 to be described later, which includes an SiNx film. FIG. 2 is a cross-sectional view schematically illustrating the active matrix substrate 100.

As illustrated in FIG. 1, the active matrix substrate 100 includes a plurality of gate wiring lines GL extending in a row direction, and a plurality of source wiring lines SL extending in a column direction. Each of regions surrounded by a pair of the gate wiring lines GL adjacent to each other and a pair of the source wiring lines SL adjacent to each other is a pixel region. That is, the active matrix substrate 100 includes a plurality of the pixel regions arrayed in a matrix shape.

A TFT 10, and a pixel electrode portion 19 (see FIG. 2, not illustrated in FIG. 1) are disposed in the pixel region. The pixel electrode portion 19 includes pixel electrodes that are electrically connected to the TFT 10. The TFT 10 is supported on the substrate, and is provided at each of intersections between the gate wiring line GL and the source wiring line SL. The TFT 10 is supplied with a gate signal (scanning signal) from the corresponding gate wiring line GL and is supplied with a source signal (display signal) from the corresponding source wiring line SL.

As illustrated in FIG. 2, the active matrix substrate 100 includes a substrate 1, a light blocking layer 2, a base coat layer 3, the TFT 10, a flattening film 16, and the pixel electrode portion 19.

The substrate 1 is transparent and has insulating properties. The light blocking layer 2 prevents photodegradation, caused by backlight light, of a semiconductor layer 11, to be described later, of the TFT 10. The light blocking layer 2 overlaps the semiconductor layer 11. The base coat layer 3 prevents impurities from the substrate 1 from affecting the semiconductor layer 11. The base coat layer 3 covers the light blocking layer 2.

The TFT 10 includes the semiconductor layer 11, a gate electrode 13, a source electrode 15A and a drain electrode 15B, a gate insulating film 12, and the interlayer film 14.

The semiconductor layer 11 is provided in island shapes on the base coat layer 3. The gate insulating film 12 insulates the semiconductor layer 11 from the gate electrode 13, and covers the semiconductor layer 11. The gate electrode 13 is provided on the gate insulating film 12, and overlaps the semiconductor layer 11. The gate electrode 13 and the gate wiring line GL (see FIG. 1) are formed by patterning the same first metal layer, and are electrically connected to each other.

The interlayer film 14 has a function of insulating the first metal layer (conductive film) constituting the gate electrode 13 and the gate wiring line GL from a second metal layer (conductive film) constituting the source electrode 15A, the drain electrode 15B, and the source wiring line SL. The interlayer film 14 has a function of supplying hydrogen used for repairing defects in the semiconductor layer 11. In the first embodiment, the interlayer film 14 is formed of a layered film. The layered film includes a silicon nitride film (layer) 14A formed of SiNx (silicon nitride) having the hydrogen supplying function, and a silicon oxide film (layer) 14B formed of SiO₂ (silicon oxide) not having the hydrogen supplying function. The silicon nitride film 14A is located on the lower layer side close to the semiconductor layer 11.

The source electrode 15A and the drain electrode 15B are provided on the interlayer film 14. The source electrode 15A and the drain electrode 15B overlap the semiconductor layer 11 and are separated from each other. The source electrode 15A and the drain electrode 15B are formed by patterning the same second metal layer as that of the source wiring lines SL (see FIG. 1). The source electrode 15A and the source wiring line SL are electrically connected to each other. The source electrode 15A and the drain electrode 15B, and the source wiring line SL formed by patterning the second metal layer may also be referred to as SE wiring lines.

The flattening film 16 levels a surface on which the pixel electrodes of the pixel electrode portion 19 are formed, and covers the TFT 10. The pixel electrode portion 19 is provided on the flattening film 16.

The pixel electrode portion 19 includes a first pixel electrode 17A, a second pixel electrode 17B, and a capacitance forming insulating film (upper insulating film) 18 provided between the first pixel electrode 17A and the second pixel electrode 17B. The first pixel electrode 17A disposed on the substrate 1 side is a pixel capacitance forming electrode for forming a pixel capacitance. The second pixel electrode 17A disposed on the first pixel electrode 17B via the capacitance forming insulating film 18 is a liquid crystal voltage applying electrode. The second pixel electrode 17B is divided into a plurality of sections by slits. The pixel capacitance is formed between the second pixel electrode 17B and the first pixel electrode 17A.

In this embodiment, inside a contact hole H2 formed in the flattening film 16, a connection electrode 17c formed of the same conductive film layer as the first pixel electrode 17A is connected to the drain electrode 15B. The connection electrode 17c and the second pixel electrode 17B are connected to each other via a contact hole formed in the capacitance forming insulating film 18. The contact hole H2 formed in the flattening film 16 electrically connects the drain electrode 15B to the above-described connection electrode 17c, and electrically connects the drain electrode 15B to the second pixel electrode 17B via the connection electrode 17c.

Next, a material of each of the components constituting the active matrix substrate 100 will be described. For example, the substrate 1 may be a glass substrate, or may be a plastic substrate. The light blocking layer 2 is made of MoW, for example. The base coat layer 3 is a layered film of SiO₂/SiNx, for example. SiNx is located on the substrate 1 side. Film thicknesses satisfy SiO₂>SiNx.

The semiconductor layer 11 is a poly-Si, an a-Si, or an In—Ga—Zn—O based oxide semiconductor, or the like. The first metal layer constituting the gate electrode 13 and the gate wiring line GL is a metal layered film of W/TaN, for example. Film thicknesses satisfy W>TaN. The second metal layer constituting the source electrode 15A, the drain electrode 15B, and the source wiring line SL is metal layered film of Ti/Al/Ti, for example. Film thicknesses satisfy Ti<Al>Ti.

The gate insulating film 12 is an inorganic oxide film of SiO₂, for example. In the interlayer film 14, the silicon nitride film 14A having the hydrogen supplying function is SiNx, and the silicon oxide film 14B is an inorganic oxide film such as SiO₂. Film thicknesses of the interlayer film 14 satisfy SiO₂>SiNx.

The flattening film 16 is a photosensitive resin such as a photosensitive acrylic resin. The film thickness of the flattening film 16 is in the order of um, and is sufficiently thicker than the film thicknesses of the other thin film portions.

The first pixel electrode 17A and the second pixel electrode 17B of the pixel electrode portion 19 are both transparent conductive films, such as indium tin oxide (ITO) film, an indium zinc oxide (IZO) film, or the like. The capacitance forming insulating film 18 is made of SiNx.

As described above, the inventors of the present application have found that the SiNx film present at the light transmitting portion is a factor that increases the internal reflection and reduces the photopic contrast. The SiNx film is used for the base coat layer 3, the interlayer film 14, and the capacitance forming insulating film 18.

Both the SiNx film and the SiO₂ film are stable insulating films, but, unlike the SiNx film, the SiO₂ film cannot supply the hydrogen used to repair defects in the semiconductor layer 11. Thus, the SiNx film is required in the interlayer film 14 that also serves to repair defects in the semiconductor layer 11. Unlike the SiNx film, the SiO₂ film cannot prevent impurities from the substrate 1 from penetrating the semiconductor layer 11. Therefore, in the top gate type, the SiNx film is required in the base coat layer 3. Further, the SiO₂ film has a high film formation temperature and needs to be processed at a high temperature. However, the SiNx film can function as an insulating film at a lower film formation temperature than the SiO₂ film. Therefore, the capacitance forming insulating film 18 formed on the flattening film 16 made of the photosensitive acrylic resin also cannot be formed as the SiO₂ film.

In a known active matrix substrate, the base coat layer 3, the interlayer film 14, and the capacitance forming insulating film 18, which all include the SiNx film, extend to the light transmitting portion.

Here, as illustrated in FIG. 2, in the active matrix substrate 100, the interlayer film 14 includes the interlayer film removed regions (first portions) RM1 that do not include the silicon nitride film 14A at the light transmitting portion.

By providing the interlayer film removed region RM1 and removing the silicon nitride film 14A of the interlayer film 14 from the light transmitting portion, reflectivity in the light transmitting portion can be reduced, and transmittance in the light transmitting portion can be increased.

Here, although the base coat layer 3 including the SiNx film is still present at the light transmitting portion, the thickness thereof with respect to the silicon nitride film 14A is sufficiently thin ( 1/10 or less). Thus, even when a removed region is provided in the base coat layer 3 at the light transmitting portion, a contribution to reducing the internal reflection and to increasing the transmittance is small.

When the base coat layer 3 is also removed, the thickness of the film to be removed exceeds 1 μm. Further, since an area of the film to be removed is large, it is necessary to make the film thicker than usual. When the thickness of the resist is increased, the resist significantly recedes. As a result, there is a demerit in that a line width loss of a portion to be protected is large and control is difficult.

By intentionally leaving the base coat layer 3 at the light transmitting portion, an etching treatment time can be shortened and the device load can be suppressed.

However, the disclosure does not exclude a configuration in which all the insulating films from the interlayer film 14 to the base coat layer 3, which reach the light transmitting portion, are removed, and such a configuration is also included in the scope of the disclosure.

### Method of Manufacturing Active Matrix Substrate

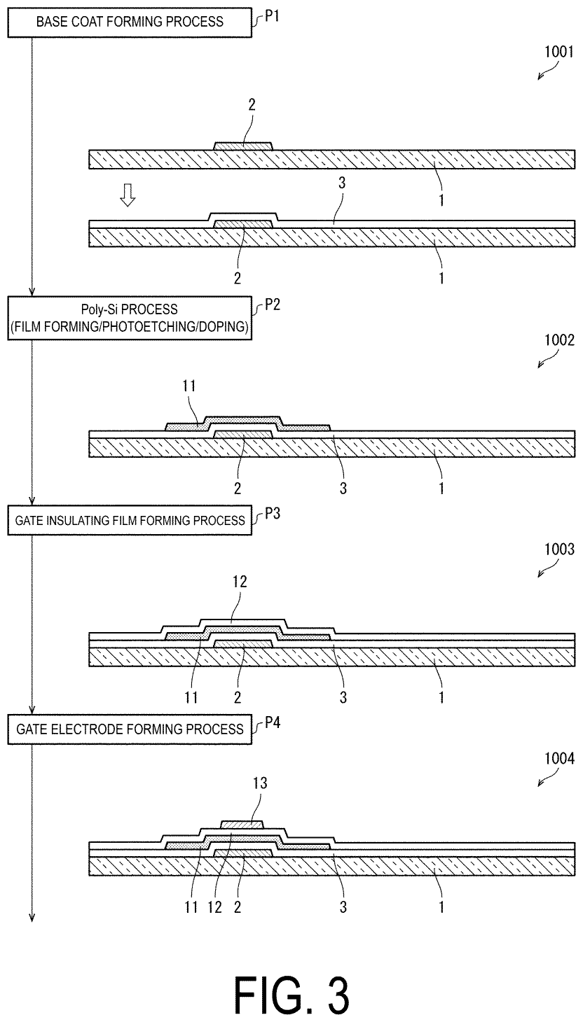

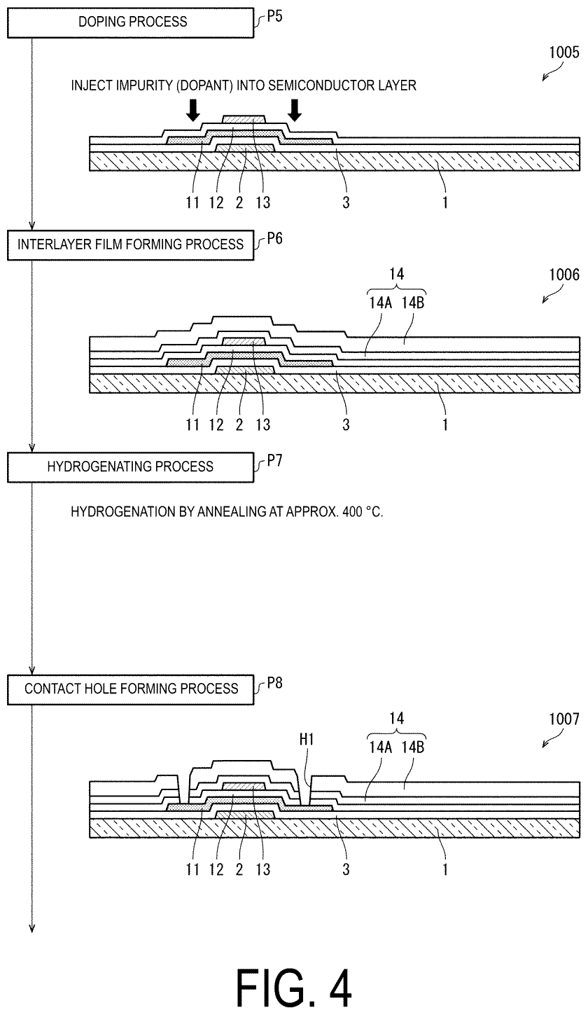

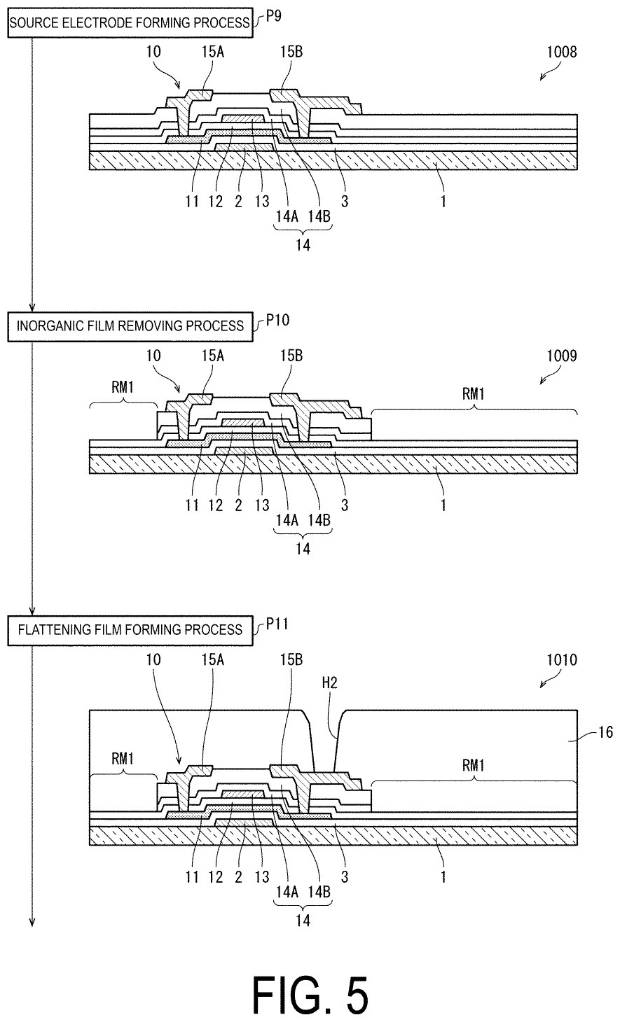

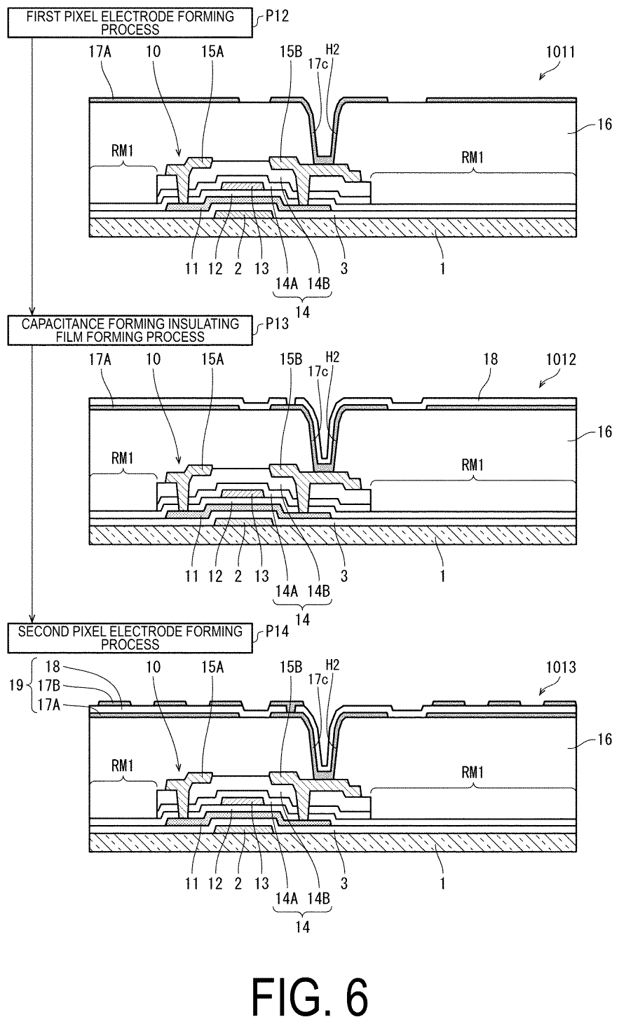

Next, a method of manufacturing the active matrix substrate 100 according to the first embodiment will be described with reference to FIGS. 3 to 6. Here, a poly-Si process is exemplified. FIGS. 3 to 6 are process views illustrating a manufacturing process, together with cross-sectional views, of the active matrix substrate 100. FIG. 4 is a continuation of FIG. 3, FIG. 5 is a continuation of FIG. 4, and FIG. 6 is a continuation of FIG. 5.

As indicated by a reference sign 1001 in FIG. 3, first, for example, a MoW film is formed on the surface of the substrate 1. Subsequently, photolithography, etching, and resist peeling and cleaning are performed to form the light blocking layer 2. Then, an SiNx film and an SiO₂ film are formed thereon in this order by plasma CVD, for example, to form the base coat layer 3 (P1: base coat forming process).

Subsequently, as indicated by a reference sign 1002 in FIG. 3, a poly-Si process is performed to form the semiconductor layer 11 on the surface of the substrate on which the base coat layer 3 is formed. The poly-Si process includes a series of processes of film forming, photoetching, and then doping (P2: poly-Si process).

Subsequently, as indicated by a reference sign 1003 in FIG. 3, an SiO₂ film is formed by plasma CVD, for example, to form the gate insulating film 12 on the surface of the substrate on which layers up to the semiconductor layer 11 are formed (P3: gate insulating film forming process).

Subsequently, as indicated by a reference sign 1004 in FIG. 3, a W film and a TaN film are sequentially formed by sputtering, for example, to form the metal layered film (first metal layer) on the substrate on which the layers up to the gate insulating film 12 are formed. Following this, photolithography, etching, and resist peeling and cleaning are performed on the metal layered film, to form the gate wiring line GL including the gate electrode 13 (P4: gate electrode forming process).

Subsequently, as indicated by a reference sign 1005 in FIG. 4, with respect to the substrate on which the layers up to the gate wiring line GL including the gate electrode 13 are formed, an impurity (dopant) is injected into the semiconductor layer 11 (P5: doping process).

Subsequently, as indicated by a reference sign 1006 in FIG. 4, an SiNx film and an SiO₂ film are sequentially formed by plasma CVD, for example, on the surface of the substrate to which the injection of the impurity into the semiconductor layer 11 is complete, to form a silicon nitride film 14A and a silicon oxide film 14B on the silicon nitride film 14A, thus forming the interlayer film 14 (P6: interlayer film forming (formation) process).

Subsequently, although a cross-sectional view thereof is not illustrated, the substrate on which the layers up to the interlayer film 14 are formed is annealed at approximately 400° C., and hydrogen is supplied to the defects in the semiconductor layer 11 to repair the defects (P7: hydrogenating process).

Subsequently, as indicated by a reference sign 1007 in FIG. 4, a contact hole H1 that penetrates the interlayer film 14 and the gate insulating film 12 is formed in the with respect to the substrate for which the processes up to the hydrogenating are complete (P8: contact hole forming process).

Subsequently, as indicated by a reference sign 1008 in FIG. 5, a Ti film, an Al film, and a Ti film are sequentially formed by sputtering, for example, on the surface of the substrate on which the processes up to forming the contact hole H1 are performed, to form the metal layered film (second metal layer). Following this, photolithography, etching, and resist peeling and cleaning are performed on the metal layered film, to form the source electrode 15A and the drain electrode 15B, and the source wiring line SL (P9: source electrode forming process).

Subsequently, as indicated by a reference sign 1009 in FIG. 5, photolithography, etching, and resist peeling and cleaning are performed on the substrate on which the layers up to the source electrode 15A and the drain electrode 15B, and the source wiring line SL are formed, to remove the interlayer film 14 at the light transmitting portion, thus forming the interlayer film removed region RM1 (P10: inorganic film removing process). The inorganic film removing process at P10 is an inorganic film removing process in which, subsequent to the hydrogenating process at P8, the silicon nitride layer is removed from at least a part of the interlayer film 14 located at the light transmitting portion, thus forming the removed region in which the silicon nitride layer is not present in the thickness direction.

Subsequently, as indicated by a reference sign 1010 in FIG. 5, a film of a photosensitive resin, such as a photosensitive acrylic resin, is formed on the surface of the substrate on which the interlayer film removed region RM1 is formed, so as to cover the TFT 10 and fill the interlayer film removed region RM1, thus forming the flattening film 16 having the contact hole H2 (P11: flattening film forming process).

Subsequently, as indicated by a reference sign 1011 in FIG. 6, an ITO film is formed by sputtering, for example, on the substrate on which the layers up to the flattening film 16 are formed and then, photolithography, etching, and resist peeling and cleaning are performed to form the first pixel electrode 17A (P12: first pixel electrode forming process).

Subsequently, as indicated by a reference sign 1012 in FIG. 6, an inorganic insulating film such as an SiNx film is formed by plasma CVD, for example, on the surface of the substrate on which the first pixel electrode 17A is formed. Following this, photolithography, etching, and resist peeling and cleaning are performed on the inorganic insulating film, to form the capacitance forming insulating film 18 (P13: capacitance forming insulating film forming process).

Furthermore, as indicated by a reference sign 1013 in FIG. 6, an ITO film is formed by sputtering, for example, on the substrate surface on which the capacitance forming insulating film 18 is formed, and then, photolithography, etching, and resist peeling and cleaning are performed to form the second pixel electrode 17B (P14: second pixel electrode forming process).

As a result of the above-described processes, the active matrix substrate 100 can be obtained in which the interlayer film 14 at the light transmitting portion is removed.

### Second Embodiment

Another embodiment of the disclosure will be described below. Further, members having the same functions as those of the members described in the above-described embodiments will be denoted by the same reference numerals and signs, and the description thereof will not be repeated for the sake of convenience of description.

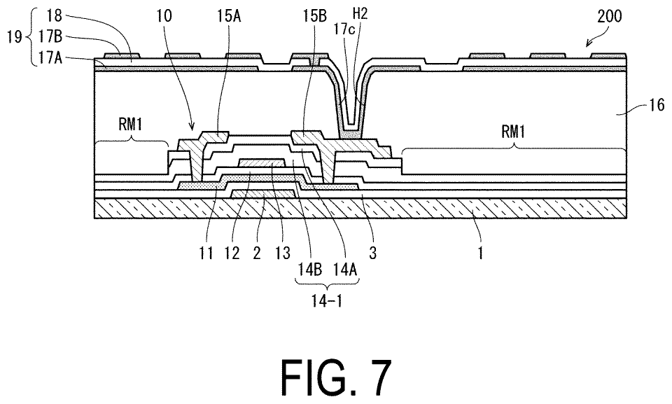

FIG. 7 is a cross-sectional view schematically illustrating an active matrix substrate 200 according to a second embodiment. Note that a plan view schematically illustrating the active matrix substrate 200 is the same as that illustrated in FIG. 1.

In the active matrix substrate 100, in the interlayer film 14, the silicon nitride film 14A that is the SiNx film is located on the side close to the semiconductor layer 11, and the silicon oxide film 14B that is the SiO₂ film is layered on the silicon nitride film 14A (see FIG. 2). This is because the silicon nitride film 14A having the hydrogen supplying function is preferably disposed closer to the semiconductor layer 11. However, in this case, in order to remove the silicon nitride film 14A, it is necessary to also remove the silicon oxide film 14B located thereon.

Here, as illustrated in FIG. 7, the active matrix substrate 200 includes an interlayer film 14-1 instead of the interlayer film 14. In the interlayer film 14-1, the silicon oxide film 14B is located on the lower layer side close to the semiconductor layer 11, and the silicon nitride film 14A is formed on the silicon oxide film 14B. That is, the layering order (film forming order) of the silicon nitride film 14A and the silicon oxide film 14B is reversed.

With such a configuration, in the inorganic film removing process, removal from the silicon nitride film 14A is possible, and the silicon oxide film 14B can be left as it is or can be partially removed, as illustrated in FIG. 7. In this way, a load in the inorganic film removing process can be reduced.

Since the layering order of the silicon nitride film 14A and the silicon oxide film 14B is reversed, the silicon oxide film 14B is interposed between the silicon nitride film 14A and the semiconductor layer 11. However, the characteristics of the TFT 10 can be obtained by optimizing process conditions (hydro-annealing conditions) in the hydrogenating process. It has been confirmed that the properties of the TFT 10 can be obtained by optimizing the process conditions in the hydrogenating process.

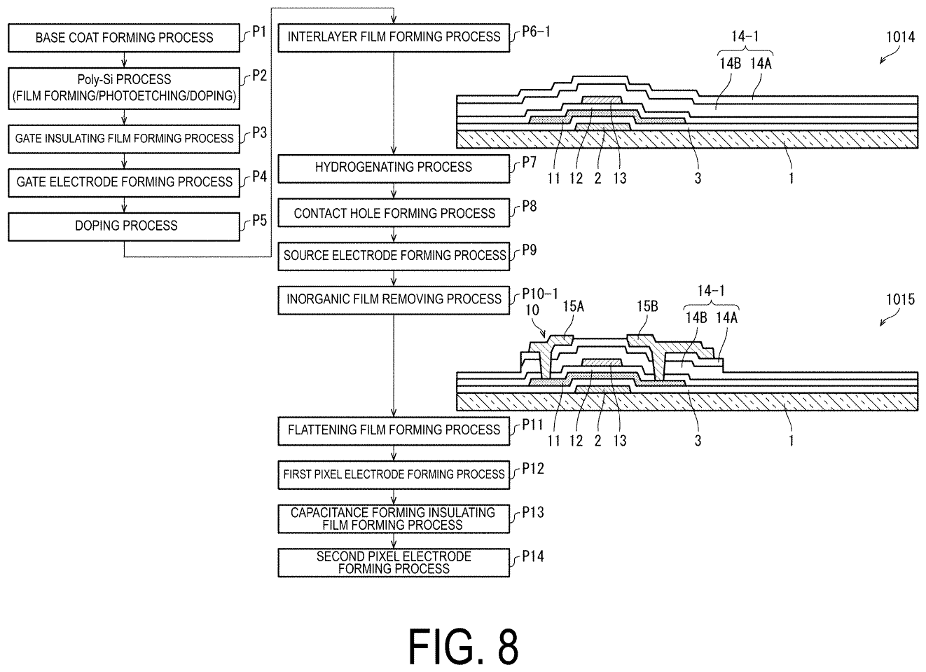

Next, a method of manufacturing the active matrix substrate 200 according to the second embodiment will be described with reference to FIG. 8. FIG. 8 is a process view illustrating a manufacturing process, together with cross-sectional views, of the active matrix substrate 200. In FIG. 8, of the processes P1 to P14 described with reference to FIGS. 3 to 6 in the first embodiment, only processes having a different processing content are illustrated using cross-sectional views of the active matrix substrate 200, and cross-sectional views are omitted for the processes having the same processing content.

Through the processes from P1 to P5, the light blocking layer 2, the base coat layer 3, the semiconductor layer 11, the gate insulating film 12, the gate electrode 13, and the gate wiring line GL are formed on the substrate 1, and an impurity is injected into the semiconductor layer 11.

Subsequently, as indicated by a reference sign 1014 in FIG. 8, using plasma CVD, for example, an SiO₂ film and an SiNx film are sequentially formed, in reverse order to the first embodiment, on the surface of the substrate for which the injection of the impurity into the semiconductor layer 11 is complete, to form the silicon oxide film 14B and the silicon nitride film 14A thereon, thus forming the interlayer film 14-1 (P6-1: interlayer film forming process).

Following this, through the processes from P7 to P9, the defects of the semiconductor layer 11 are repaired, and the contact hole H1, the source electrode 15A and the drain electrode 15B, and the source wiring line SL are formed.

Subsequently, as indicated by a reference sign 1015 in FIG. 8, photolithography, etching, and resist peeling and cleaning are performed on the substrate on which the layers up to the source electrode 15A and the drain electrode 15B, and the source wiring line SL are formed, to remove the silicon nitride film 14A located on the surface of the interlayer film 14-1 at the light transmitting portion, thus forming the interlayer film removed region (first portion) RM1 (P10-1: inorganic film removing process). In the process P10-1, the silicon nitride film 14A is completely removed, but there is no problem even when the silicon oxide film 14B located below the silicon nitride film 14A is removed.

Following this, through the processes from P11 to P14, the flattening film 16, the first pixel electrode 17A, the capacitance forming insulating film 18, and the second pixel electrode 17B are formed.

### Third Embodiment

Another embodiment of the disclosure will be described below. Further, members having the same functions as those of the members described in the above-described embodiments will be denoted by the same reference numerals and signs, and the description thereof will not be repeated for the sake of convenience of description.

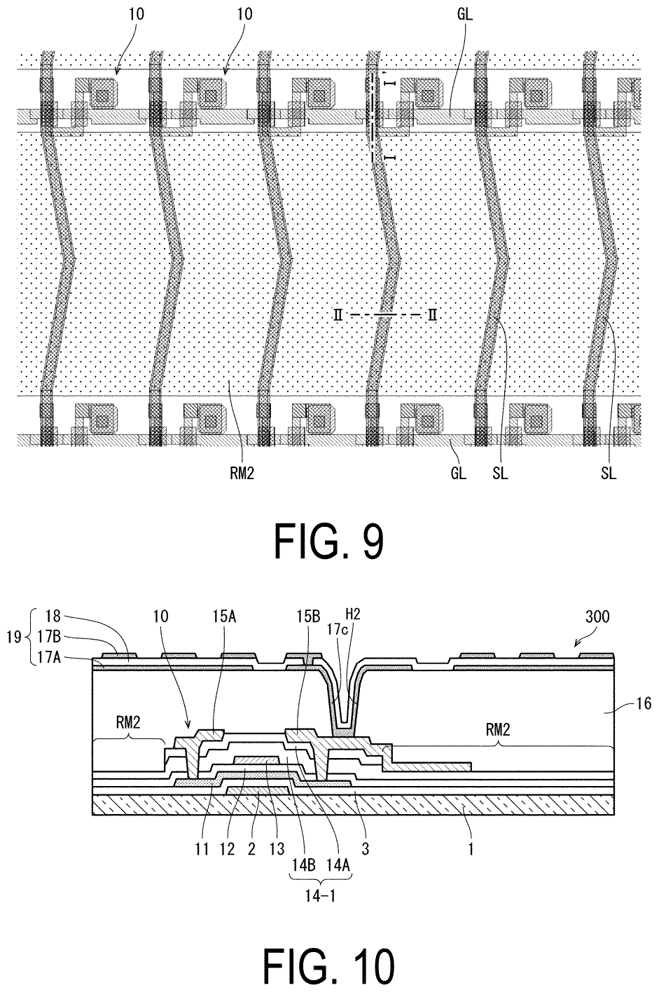

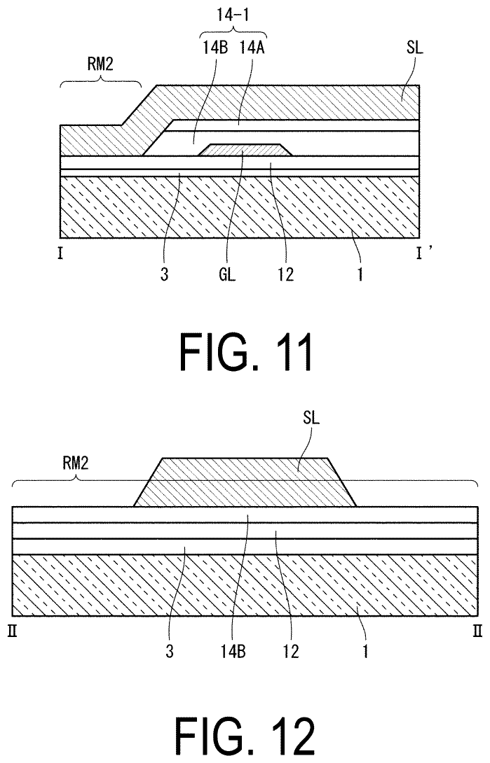

FIG. 9 is a plan view schematically illustrating an active matrix substrate 300 according to a third embodiment. In FIG. 9, a dotted region is an interlayer film removed region (first portion) RM2 obtained by removing the silicon nitride film 14A of the interlayer film 14-1. FIG. 10 is a cross-sectional view schematically illustrating the active matrix substrate 300. FIG. 11 is a cross-sectional view taken along a line I-I′ in FIG. 9. FIG. 12 is a cross-sectional view taken along a line II-II in FIG. 9. In the third embodiment, in a similar manner to the second embodiment, a part of the silicon oxide film 14B is removed together with the silicon nitride film 14A.

In the third embodiment, only the differences with reference to the configuration and the method of manufacturing according to the second embodiment will be described, but the third embodiment can also be combined with the configuration and the method of manufacturing according to the first embodiment. In other words, in FIG. 9, the dotted interlayer film removed region RM2 may be a region in which the interlayer film 14 is removed.

In the second embodiment described above, the silicon nitride film 14A and the silicon oxide film 14B of the interlayer film 14-1 are partially removed in the processes subsequent to the source electrode forming process P9. In this case, it is necessary to form a resist in which a margin is provided around the source wiring line SL and to perform etching so that the source wiring line SL is not affected in the inorganic film removing process that is the subsequent process. Therefore, the silicon nitride film 14A around (at edge portions of) the source wiring line SL cannot be removed. However, as long as the interlayer film 14-1 (14) is present at a portion where the gate wiring line GL and the TFT 10 are provided, there is no problem in terms of the electric circuit.

Here, as illustrated in FIG. 9, in the active matrix substrate 300 according to the third embodiment, the inorganic film removing process P10 is performed in advance of the source electrode forming process P9, leaving only a portion at which the gate wiring line GL and the TFT 10 are present. In other words, the silicon nitride layer is removed at the first region, which does not include the portion at which the gate wiring line GL and the TFT 10 are located. Here, a part of the silicon oxide film 14B is also removed. By manufacturing in this way, the removed area of the silicon nitride film 14A of the light transmitting portion can be further increased.

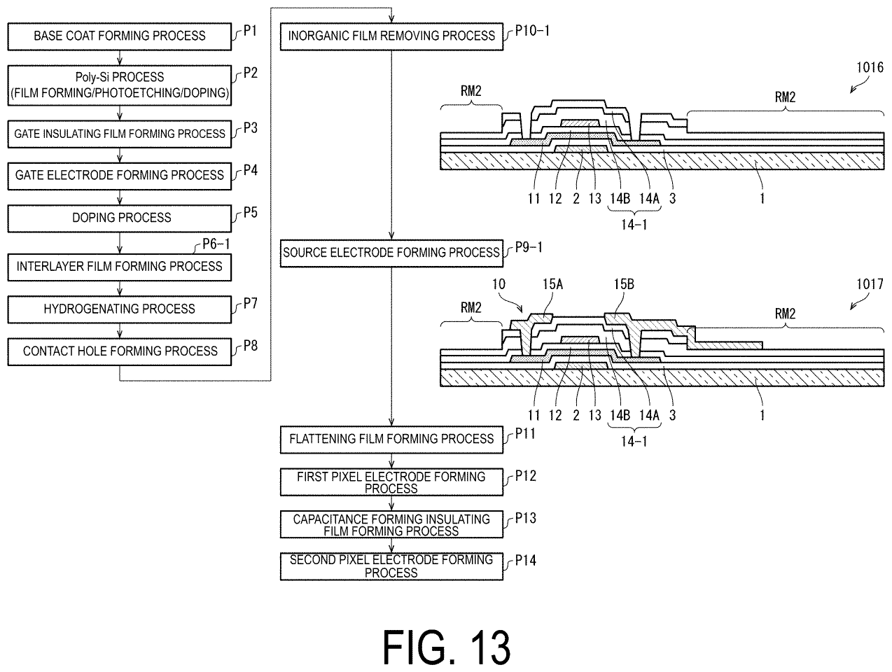

Next, a method of manufacturing the active matrix substrate 300 according to the third embodiment will be described with reference to FIG. 13. FIG. 13 is a process view illustrating a manufacturing process, together with cross-sectional views, of the active matrix substrate 300. In FIG. 13, of the processes P1 to P14, P6-1, and P10-1 described with reference to FIGS. 3 to 6 and FIG. 8 in the first and second embodiments, only processes having a different processing content are illustrated, using cross-sectional views of the active matrix substrate 300, and cross-sectional views of processes having the same processing content are omitted.

As illustrated in FIG. 13, through the processes from P1 to P8, the processes are performed up to forming the contact hole H1 in the gate insulating film 12 and the interlayer film 14-1.

Subsequently, as indicated by a reference sign 1016 in FIG. 13, the silicon nitride film 14A in the light transmitting portion and a part of the silicon oxide film 14B located below the silicon nitride film 14A are removed to form the interlayer film removed region RM2 (P10-1: inorganic film removing process). In the process P10-1, the silicon nitride film 14A is completely removed, but there is no problem even when the silicon oxide film 14B located below the silicon nitride film 14A is removed.

Subsequently, as indicated by a reference sign 1017 in FIG. 13, the source electrode 15A and the drain electrode 15B, and the source wiring line SL are formed on the substrate on which the interlayer film removed region RM2 is formed in the interlayer film 14-1 (P9-1: source electrode forming process). The drain electrode 15B can be formed at a portion at which the drain electrode 15B cannot be formed in the active matrix substrates 100 and 200.

Following this, through the processes from P11 to P14, the flattening film 16, the first pixel electrode 17A, the capacitance forming insulating film 18, and the second pixel electrode 17B are formed.

As illustrated in FIG. 9 and FIG. 10, in the active matrix substrate 300 manufactured in this way, a region not included in the interlayer film removed region RM1 is included in the interlayer film removed region RM2, and the drain electrode 15B can be formed in a portion at which the drain electrode 15B cannot be formed in the active matrix substrates 100 and 200.

As illustrated in FIG. 11, an end surface of the interlayer film 14-1 obtained by removing the silicon nitride film 14A and a part of the silicon oxide film 14B located below the silicon nitride film 14A in the inorganic film removing process P10-1 has a gently tapered shape expanding toward the substrate 1 side. Thus, even when the source wiring line SL is provided from a portion at which the interlayer film 14-1 is not removed to the interlayer film removed region RM2, there is no concern with regard to disconnection due to step breakage of the source wiring line SL or the like, nor concern with regard to an increase in a resistance value.

Although it is an estimate, the inorganic film removed area with respect to one pixel is 59% in the active matrix substrates 100 and 200, and is 69% in the active matrix substrate 300. That is, the light transmitting portion from which the silicon nitride film 14A is removed increases by approximately 108. Further, the silicon nitride film 14A remaining around the source wiring line SL for the purpose of the margin can be eliminated. Thus, an increase in the internal reflection and a decrease in the transmittance at this portion can be avoided.

### Fourth Embodiment

Another embodiment of the disclosure will be described below. Further, members having the same functions as those of the members described in the above-described embodiments will be denoted by the same reference numerals and signs, and the description thereof will not be repeated for the sake of convenience of description.

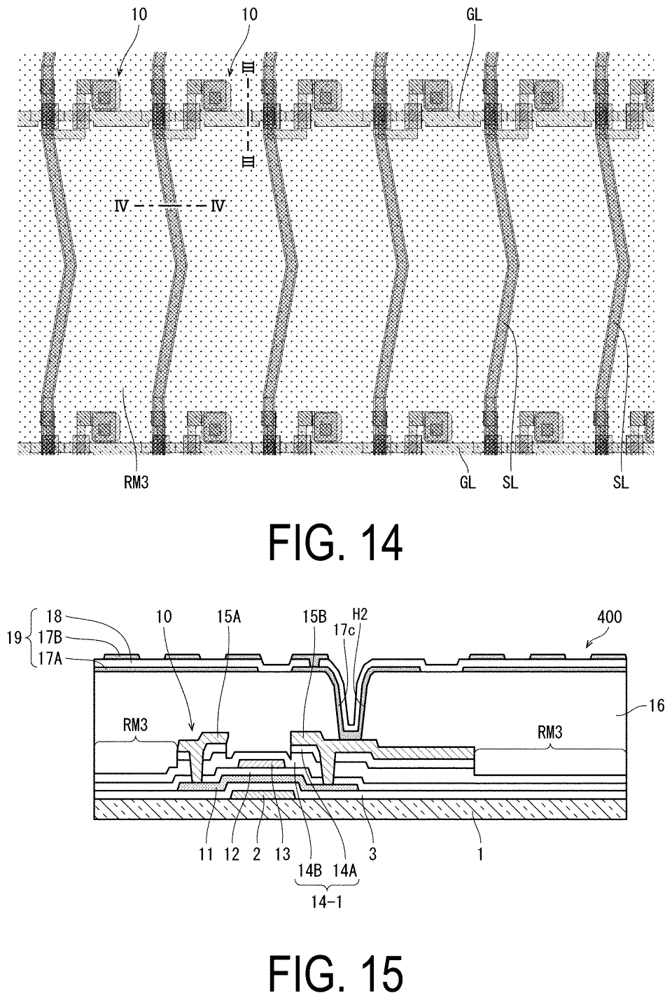

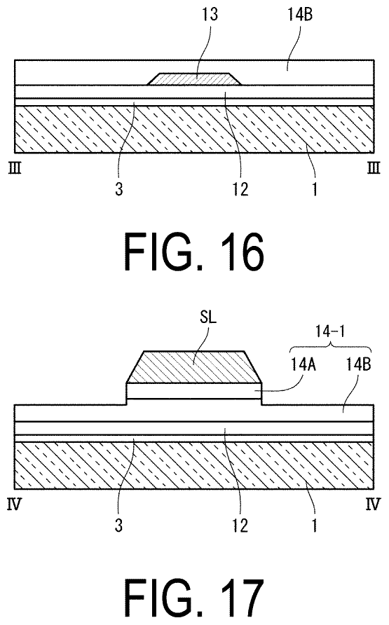

FIG. 14 is a plan view schematically illustrating an active matrix substrate 400 according to a fourth embodiment. In FIG. 14, a dotted region is an interlayer film removed region RM3, obtained by removing the silicon nitride film 14A of the interlayer film 14-1. FIG. 15 is a cross-sectional view schematically illustrating the active matrix substrate 400. FIG. 16 is a cross-sectional view taken along a line III-III in FIG. 14. FIG. 17 is a cross-sectional view taken along a line IV-IV in FIG. 14.

In the active matrix substrate 200 according to the second embodiment described above, after the hydrogenating process P7 is completed, the silicon nitride film 14A as the insulating film is not required, and it is sufficient that only the silicon oxide film 14B remains as the interlayer film.

Here, in the active matrix substrate 400 according to the fourth embodiment, using the source electrode 15A and the drain electrode 15B, and the source wiring line SL as a mask, only the silicon nitride film 14A is removed.

By manufacturing in this way, the silicon nitride film 14A can be entirely removed except for the portions at which the source electrode 15A and the drain electrode 15B, and the source wiring line SL are present. In this way, the internal reflection can be reduced and the transmittance can be improved more than in the active matrix substrate 300 according to the third embodiment.

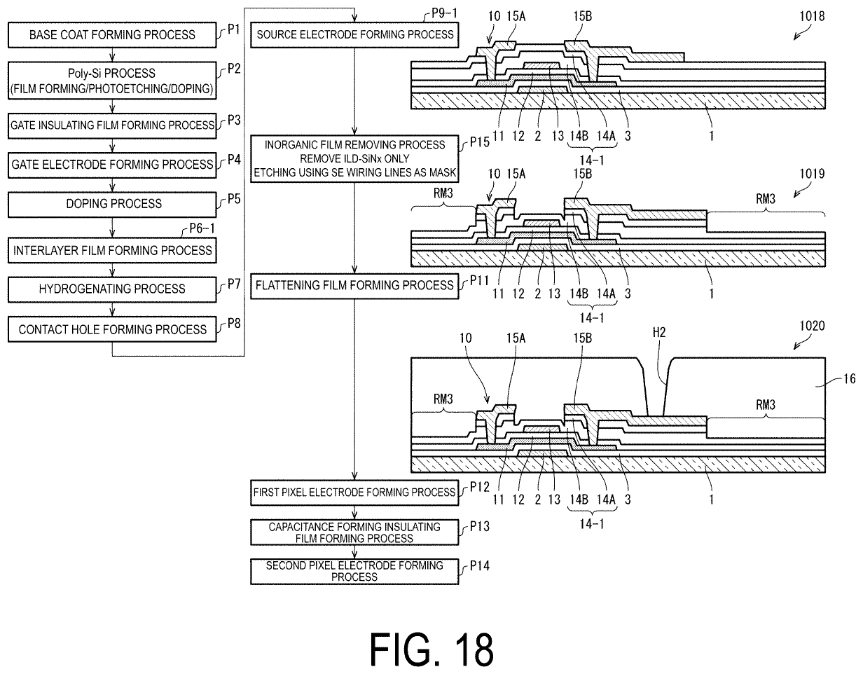

Next, a method of manufacturing the active matrix substrate 400 according to the fourth embodiment will be described with reference to FIG. 18. FIG. 18 is a process view illustrating a manufacturing process, together with cross-sectional views, of the active matrix substrate 400. Note that in FIG. 18 also, of the processes P1 to P14, P6-1, and P10-1 described with reference to FIGS. 3 to 6 and FIG. 8 in the first and second embodiments, only processes having a different processing content are illustrated, using cross-sectional views of the active matrix substrate 400, and cross-sectional views of processes having the same processing content are omitted.

As illustrated in FIG. 18, through the processes from P1 to P8, the processes are performed up to forming the contact hole H1 in the gate insulating film 12 and the interlayer film 14-1.

Subsequently, as indicated by a reference sign 1018 in FIG. 18, the source electrode 15A and the drain electrode 15B, and the source wiring line SL, are formed on the substrate on which the layers up to the interlayer film 14-1 are formed (P9-1: source electrode forming process). The drain electrode 15B can be formed at a portion at which the drain electrode 15B cannot be formed in the active matrix substrates 100 and 200.

Subsequently, as indicated by a reference sign 1019 in FIG. 18, etching is performed using the source electrode 15A and the drain electrode 15B, and the source wiring line SL as the mask, to remove only the silicon nitride film 14A in the interlayer film 14-1, thus forming the interlayer film removed region RM3 (P10-2: inorganic film removing process).

However, when the second metal layer is formed of the metal layered film of Ti/Al/Ti, the upper layer Ti is removed by a fluorine etching gas when removing the silicon nitride film 14A (see reference sign 1019 in FIG. 18). Thus, the second metal layer becomes a metal layered film of Al/Ti. The second metal layer may be the metal layered film of Al/Ti in which the upper layer is Al that is not etched by the fluorine gas.

Following this, through the processes from P11 to P14, the flattening film 16, the first pixel electrode 17A, the capacitance forming insulating film 18, and the second pixel electrode 17B are formed.

As illustrated in FIG. 15, in the active matrix substrate 400 manufactured in this way, the silicon nitride film 14A is completely removed except for portions located under the source electrode 15A and the drain electrode 15B, and the source wiring line SL that are formed of the second metal layer. Since the silicon oxide film 14B remains on the TFT 10 and the gate wiring line GL, even when the silicon nitride film 14A is completely removed, a state of being covered with the insulating film is maintained.

Note that, in the inorganic film removing process P10-2, when the silicon nitride film 14A is removed while using the source electrode 15A and the drain electrode 15B, and the source wiring line SL as the mask, the metal of the upper layer (here, Ti) in the second metal layer is damaged and disappears due to the etching with the fluorine gas.

Here, with respect to the hole H2 in the flattening film 16, after forming the contact hole H2, by removing Al inside the hole using an alkaline solution such as a developing solution and exposing the lower layer of Ti, the contact hole H2 can be brought into contact with the connection electrode 17c formed of the same transparent conductive film as the first pixel electrode 17A.

Alternatively, the silicon nitride film 14A may be removed subsequent to disposing the transparent conductive film in advance at a contact portion with the connection electrode 17c in the drain electrode 15B. In this way, the transparent conductive film disposed at the contact portion remains even after the etching. Thus, a contact resistance with the connection electrode 17c can be obtained without any problem.

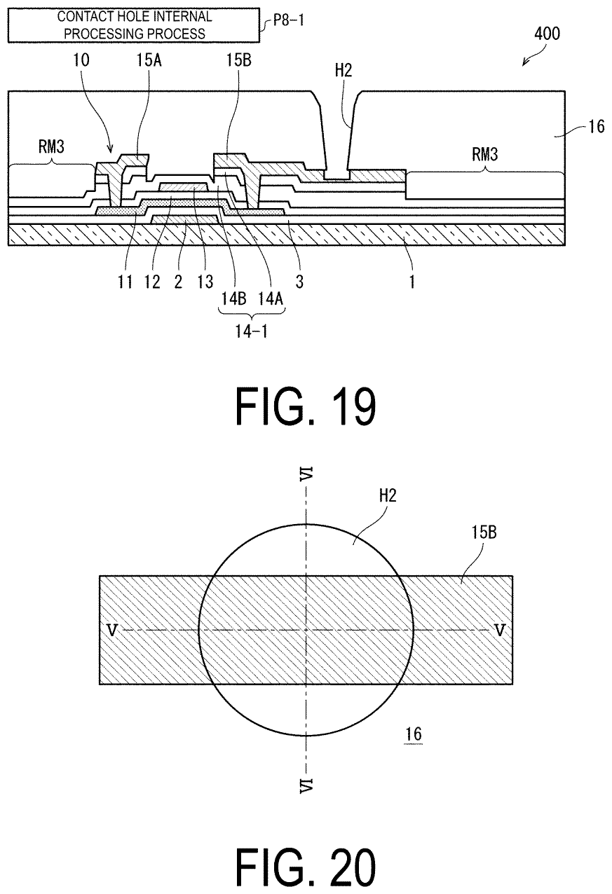

As illustrated in FIG. 19, only the Al layer in the drain electrode 15B (second metal layer) inside the contact hole H2 opened in the flattening film 16 may be removed. FIG. 19 is a cross-sectional view illustrating processing inside the contact hole H2 opened in the flattening film 16. By using a mixed solution of acetic acid/phosphoric acid/nitric acid, or a developing solution (alkaline solution), it is possible to remove only Al and leave the lower layer Ti.

However, since the etching using the mixed solution of acetic acid/phosphoric acid/nitric acid, or using the developing solution (alkaline solution) is isotropic etching, the etching of Al in the contact hole H2 extends in the lateral direction wider than the contact hole H2. Therefore, when forming the transparent conductive film (the same transparent conductive film as that of the first pixel electrode 17A) serving as the connection electrode 17c at that portion, the transparent conductive film is subject to step breakage and the contact cannot be obtained.

Here, as illustrated in FIG. 20, by disposing a wiring line end of the drain electrode 15B in the contact hole H2 formed in the flattening film 16, the lower layer Ti of the drain electrode 15B can be brought into contact with the connection electrode 17c. FIG. 20 is a view illustrating a positional relationship between the drain electrode 15B and the contact hole H2 opened in the flattening film 16.

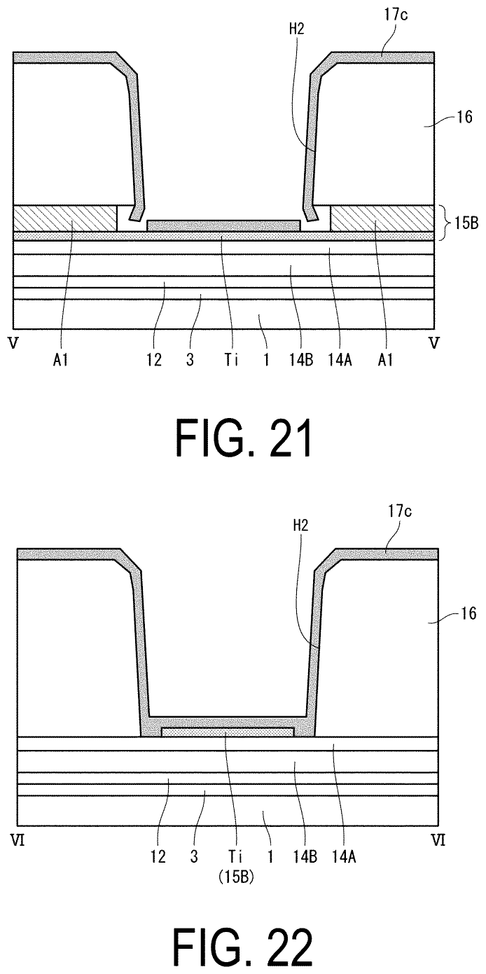

FIG. 21 is a cross-sectional view taken along a line V-V in FIG. 20. FIG. 22 is a cross-sectional view taken along a line VI-VI in FIG. 20. As illustrated in FIG. 21, a portion at which the wiring line end of the drain electrode 15B is not located in the contact hole H2 is removed by etching in the lateral direction of the AI layer, so that the connection electrode 17c is disconnected at that portion. On the other hand, as illustrated in FIG. 22, since the wiring line end of the drain electrode 15B is located in the contact hole H2, the connection electrode 17c is in contact with the Ti layer that is the lower layer.

### Fifth Embodiment

Another embodiment of the disclosure will be described below. Further, members having the same functions as those of the members described in the above-described embodiments will be denoted by the same reference numerals and signs, and the description thereof will not be repeated for the sake of convenience of description.

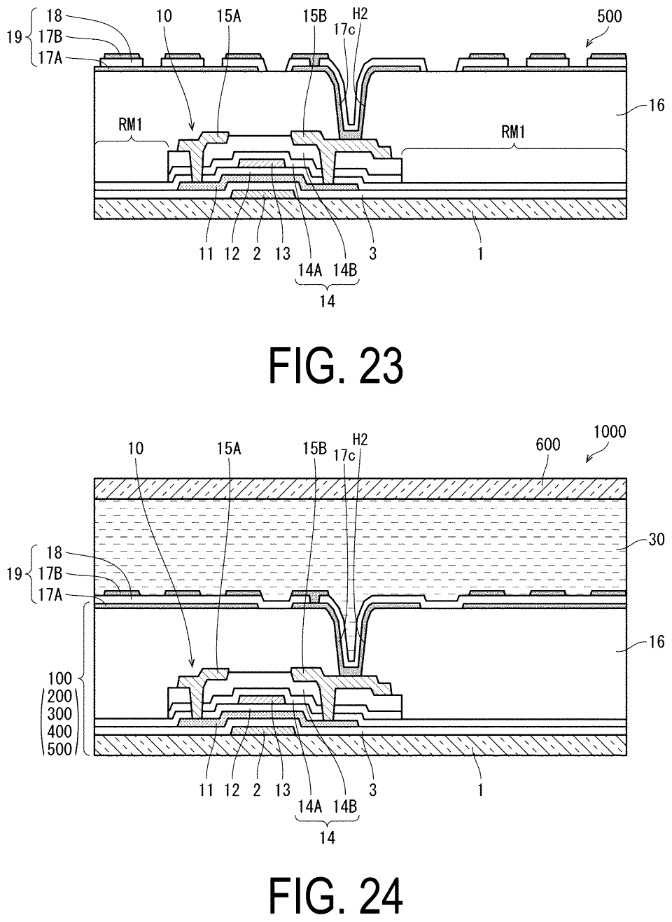

FIG. 23 is a cross-sectional view schematically illustrating an active matrix substrate 500 according to a fifth embodiment. Note that a plan view schematically illustrating the active matrix substrate 500 is the same as that illustrated in FIG. 1. In the fifth embodiment, only the differences with reference to the configuration and the method of manufacturing according to the first embodiment will be described, but the fifth embodiment can also be combined with the configurations and the methods of manufacturing according to the second to fourth embodiments.

In the active matrix substrate 100 (200 to 400), the capacitance forming insulating film 18 provided between the first pixel electrode 17A and the second pixel electrode 17B extends to the light transmitting portion. As described above, since the capacitance forming insulating film 18 is the SiNx film, it acts to increase the internal reflection and decrease the transmittance. Moreover, since the capacitance forming insulating layer 18 is located in the upper layer, it can be easily removed.

Here, as illustrated in FIG. 23, in the active matrix substrate 500 according to the fifth embodiment, excepting a portion required to form the pixel capacitance by the first pixel electrode 17A and the second pixel electrode 17B, the capacitance forming insulating film 18 is removed from other portions. In other words, in a region in which the pixel capacitance is not formed by the first pixel electrode 17A and the second pixel electrode 17B, a second portion is provided at which the capacitance forming insulating film 18 is not provided. In this way, the internal reflection can be even further reduced and the transmittance even further improved.

As a method of manufacturing, first the capacitance forming insulating film 18 is formed in the capacitance forming insulating film forming process P13. Subsequently, photolithography, etching, and resist peeling and cleaning are performed, and the capacitance forming insulating film 18 from which unnecessary portions are removed is thus formed.

### Sixth Embodiment

Another embodiment of the disclosure will be described below. Further, members having the same functions as those of the members described in the above-described embodiments will be denoted by the same reference numerals and signs, and the description thereof will not be repeated for the sake of convenience of description.

The active matrix substrates 100, 200, 300, 400, and 500 according to the first to fifth embodiments can be suitably used in a liquid crystal display device. FIG. 24 illustrates an example of the liquid crystal display device.

A liquid crystal display device 1000 illustrated in FIG. 24 includes the active matrix substrate 100 (or the active matrix substrate 200, 300, 400, or 500), a counter substrate 600 provided facing the active matrix substrate 100, and a liquid crystal layer 30 provided between the active matrix substrate 100 and the counter substrate 600.

Alignment films (not illustrated) are respectively provided on the outermost surface, on the liquid crystal layer 30 side, of each of the active matrix substrate 100 and the counter substrate 600. The counter substrate 600 typically includes a color filter layer and a black matrix (both not illustrated). A thickness (cell gap) of the liquid crystal layer 30 is defined by a columnar spacer (not illustrated) provided on the liquid crystal layer 30 side of the counter substrate 600 or the liquid crystal layer 30 side of the active matrix substrate 100.

### Supplement

An active matrix substrate according to a first aspect of the disclosure includes a plurality of pixel regions arrayed in a matrix shape. The active matrix substrate includes a substrate, and a TFT supported on the substrate and provided corresponding to each of the plurality of pixel regions, the TFT including a semiconductor layer, a gate electrode, a gate insulating film, a source electrode and a drain electrode, and an interlayer film. The active matrix substrate includes a plurality of gate wiring lines formed from the same conductive film as the gate electrode, and extending in a row direction, and a plurality of source wiring lines formed from the same conductive film as the source electrode and the drain electrode, and extending in a column direction. A light transmitting portion is provided, the TFT, the gate wiring line, and the source wiring line not being disposed at the light transmitting portion. The interlayer film includes a silicon nitride layer formed of silicon nitride and a silicon oxide layer formed of silicon oxide, and the interlayer film includes a first portion at the light transmitting portion, the first portion not including the silicon nitride layer.

In the first aspect described above, in the active matrix substrate according to a second aspect of the disclosure, in the interlayer film, the silicon nitride layer is located on a lower layer side close to the semiconductor layer, and the first portion does not include the silicon oxide layer.

In the first aspect described above, in the active matrix substrate according to a third aspect of the disclosure, in the interlayer film, the silicon oxide layer is located on a lower layer side close to the semiconductor layer, and the first portion includes the silicon oxide layer.

In the first aspect described above, in the active matrix substrate according to a fourth aspect of the disclosure, the first portion is formed in a first region, the first region not including a portion at which the gate wiring line and the TFT are located, and the source wiring line is located on the first portion.

In the first aspect described above, in the active matrix substrate according to a fifth aspect of the disclosure, the first portion is formed over an entire surface, excepting a lower side of the source electrode and the drain electrode, and of the source wiring line.

In any one of the first to fifth aspects described above, the active matrix substrate according to a sixth aspect of the disclosure includes a flattening film covering the TFT, and a pixel electrode portion provided on the flattening film and electrically connected to the TFT. The pixel electrode portion includes a first pixel electrode, a second pixel electrode, an upper insulating film provided between the first pixel electrode and the second pixel electrode and formed of silicon nitride, and a second portion provided in a region in which a pixel capacitance is not formed by the first pixel electrode and the second pixel electrode, the upper insulating film not being provided at the second portion.

A liquid crystal display device according to a seventh aspect of the disclosure includes the active matrix substrate according to any one of the first to sixth aspects described above, a counter substrate disposed facing the active matrix substrate, and a liquid crystal layer provided between the active matrix substrate and the counter substrate.

A method of manufacturing an active matrix substrate according to an eighth aspect of the disclosure is a method of manufacturing an active matrix substrate that includes a substrate and a TFT, the TFT being supported on the substrate and being provided corresponding to each of a plurality of pixel regions arrayed in a matrix shape, the TFT including a semiconductor layer, a gate electrode, a gate insulating film, a source electrode and a drain electrode, and an interlayer film, and the active matrix substrate including a light transmitting portion at which the TFT, a gate wiring line, and a source wiring line are not disposed. The method includes interlayer film forming of forming an interlayer film covering the gate electrode and the gate wiring line, the interlayer film including a silicon nitride layer formed of silicon nitride and a silicon oxide layer formed of silicon oxide. The method includes hydrogenating of repairing defects in the semiconductor layer, using hydrogen supplied from the silicon nitride layer, and inorganic film removing of, subsequent to the hydrogenating, removing the silicon nitride layer in at least a part of the interlayer film located at the light transmitting portion, to form a removed region, the silicon nitride layer not being present in a film thickness direction in the removed region.

In the eighth aspect described above, the method of manufacturing the active matrix substrate according to a ninth aspect of the disclosure includes source electrode forming of, subsequent to the hydrogenating, forming, on the interlayer film, the source electrode and the drain electrode, and a source wiring line electrically connected to the source electrode, using a second metal layer. In the interlayer film forming, the silicon nitride layer is formed first, and the silicon oxide layer is formed on the silicon nitride layer, and in the inorganic film removing, subsequent to the source electrode forming, at least a part of the interlayer film located at the light transmitting portion is removed to form a removed region, the interlayer film not being present in a film thickness direction in the removed region.

In the eighth aspect described above, the method of manufacturing the active matrix substrate according to a tenth aspect of the disclosure includes source electrode forming of, subsequent to the hydrogenating, forming, on the interlayer film, the source electrode and the drain electrode, and a source wiring line electrically connected to the source electrode, using a second metal layer. In the interlayer film forming, the silicon oxide layer is formed first, and the silicon nitride layer is formed on the silicon oxide layer, and in the inorganic film removing, subsequent to the source electrode forming, at least a part of the silicon nitride layer located at the light transmitting portion is removed to form a removed region, the silicon nitride layer not being present in a film thickness direction in the removed region.

In the eighth aspect described above, in the method of manufacturing the active matrix substrate according to an eleventh aspect of the disclosure, in the inorganic film removing, subsequent to the hydrogenating, the silicon nitride layer is removed and the silicon oxide layer is left in a first region not including a portion at which the gate wiring line and the TFT are located. The method includes source electrode forming of forming, on the interlayer film from which the silicon nitride layer is removed, the source electrode and the drain electrode, and a source wiring line electrically connected to the source electrode, using a second metal layer.

In the eighth aspect described above, the method of manufacturing the active matrix substrate according to a twelfth aspect of the disclosure includes source electrode forming of, subsequent to the hydrogenating, forming, on the interlayer film, the source electrode and the drain electrode, and a source wiring line electrically connected to the source electrode, using a second metal layer. In the interlayer film forming, the silicon oxide layer is formed first, and the silicon nitride layer is formed on the silicon oxide layer, and in the inorganic film removing, subsequent to the source electrode forming, the source electrode, the drain electrode, and the source wiring line are used as a mask to remove the silicon nitride layer and leave the silicon oxide layer.

The disclosure is not limited to the embodiments described above, and various modifications may be made within the scope of the claims. Embodiments obtained by appropriately combining technical approaches disclosed in the different embodiments also fall within the technical scope of the disclosure. Furthermore, novel technical features can be formed by combining the technical approaches disclosed in the embodiments.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. An active matrix substrate including a plurality of pixel regions arrayed in a matrix shape, the active matrix substrate comprising:
a substrate;
a TFT supported on the substrate and provided corresponding to each of the plurality of pixel regions, the TFT including a semiconductor layer, a gate electrode, a gate insulating film, a source electrode and a drain electrode, and an interlayer film;
a plurality of gate wiring lines formed from the same conductive film as the gate electrode, and extending in a row direction; and
a plurality of source wiring lines formed from the same conductive film as the source electrode and the drain electrode, and extending in a column direction,
wherein a light transmitting portion is provided, the TFT, the gate wiring line, and the source wiring line not being disposed at the light transmitting portion,
the interlayer film includes a silicon nitride layer formed of silicon nitride and a silicon oxide layer formed of silicon oxide, and
the interlayer film includes a first portion at the light transmitting portion, the first portion not including the silicon nitride layer.

2. The active matrix substrate according to claim 1,
wherein, in the interlayer film, the silicon nitride layer is located on a lower layer side close to the semiconductor layer, and
the first portion does not include the silicon oxide layer.

3. The active matrix substrate according to claim 1,
wherein, in the interlayer film, the silicon oxide layer is located on a lower layer side close to the semiconductor layer, and
the first portion includes the silicon oxide layer.

4. The active matrix substrate according to claim 1,
wherein the first portion is formed in a first region, the first region not including a portion at which the gate wiring line and the TFT are located, and
the source wiring line is located on the first portion.

5. The active matrix substrate according to claim 1,
wherein the first portion is formed over an entire surface, excepting a lower side of the source electrode and the drain electrode, and of the source wiring line.

6. The active matrix substrate according to claim 1, further comprising:
a flattening film covering the TFT; and
a pixel electrode portion provided on the flattening film and electrically connected to the TFT,
wherein the pixel electrode portion includes
a first pixel electrode,
a second pixel electrode,
an upper insulating film provided between the first pixel electrode and the second pixel electrode and formed of silicon nitride, and
a second portion provided in a region in which a pixel capacitance is not formed by the first pixel electrode and the second pixel electrode, the upper insulating film not being provided at the second portion.

7. A liquid crystal display device, comprising:
the active matrix substrate according to claim 1;
a counter substrate disposed facing the active matrix substrate; and
a liquid crystal layer provided between the active matrix substrate and the counter substrate.

8. A method of manufacturing an active matrix substrate that includes a substrate and a TFT, the TFT being supported on the substrate and being provided corresponding to each of a plurality of pixel regions arrayed in a matrix shape, the TFT including a semiconductor layer, a gate electrode, a gate insulating film, a source electrode and a drain electrode, and an interlayer film, and the active matrix substrate including a light transmitting portion at which the TFT, a gate wiring line, and a source wiring line are not disposed, the method comprising:
interlayer film forming of forming an interlayer film covering the gate electrode and the gate wiring line, the interlayer film including a silicon nitride layer formed of silicon nitride and a silicon oxide layer formed of silicon oxide;
hydrogenating of repairing defects in the semiconductor layer, using hydrogen supplied from the silicon nitride layer; and
inorganic film removing of, subsequent to the hydrogenating, removing the silicon nitride layer in at least a part of the interlayer film located at the light transmitting portion, to form a removed region, the silicon nitride layer not being present in a film thickness direction in the removed region.

9. The method of manufacturing the active matrix substrate according to claim 8, comprising:
source electrode forming of, subsequent to the hydrogenating, forming, on the interlayer film, the source electrode and the drain electrode, and a source wiring line electrically connected to the source electrode, using a second metal layer,
wherein, in the interlayer film forming, the silicon nitride layer is formed first, and the silicon oxide layer is formed on the silicon nitride layer, and
in the inorganic film removing, subsequent to the source electrode forming, at least a part of the interlayer film located at the light transmitting portion is removed to form a removed region, the interlayer film not being present in a film thickness direction in the removed region.

10. The method of manufacturing the active matrix substrate according to claim 8, comprising:
source electrode forming of, subsequent to the hydrogenating, forming, on the interlayer film, the source electrode and the drain electrode, and a source wiring line electrically connected to the source electrode, using a second metal layer,
wherein, in the interlayer film forming, the silicon oxide layer is formed first, and the silicon nitride layer is formed on the silicon oxide layer, and
in the inorganic film removing, subsequent to the source electrode forming, at least a part of the silicon nitride layer located at the light transmitting portion is removed to form a removed region, the silicon nitride layer not being present in a film thickness direction in the removed region.

11. The method of manufacturing the active matrix substrate according to claim 8,
wherein, in the inorganic film removing, subsequent to the hydrogenating, the silicon nitride layer is removed and the silicon oxide layer is left in a first region not including a portion at which the gate wiring line and the TFT are located, and
the method includes
source electrode forming of forming, on the interlayer film from which the silicon nitride layer is removed, the source electrode and the drain electrode, and a source wiring line electrically connected to the source electrode, using a second metal layer.

12. The method of manufacturing the active matrix substrate according to claim 8, comprising:
source electrode forming of, subsequent to the hydrogenating, forming, on the interlayer film, the source electrode and the drain electrode, and a source wiring line electrically connected to the source electrode, using a second metal layer,
wherein, in the interlayer film forming, the silicon oxide layer is formed first, and the silicon nitride layer is formed on the silicon oxide layer, and
in the inorganic film removing, subsequent to the source electrode forming, the source electrode, the drain electrode, and the source wiring line are used as a mask to remove the silicon nitride layer and leave the silicon oxide layer.
